(19) United States
(12) Patent Application Publication
(10) Pub. No.: US 2021/0396881 A1
(43) Pub. Date: Dec. 23, 2021

(54) OPTICAL DISTANCE MEASUREMENT DEVICE AND OPTICAL DISTANCE MEASUREMENT METHOD

(71) Applicant: SONY SEMICONDUCTOR SOLUTIONS CORPORATION, Atsugi-shi, Kanagawa (JP)

(72) Inventor: Shunji MAEDA, Kanagawa (JP)

(21) Appl. No.: 17/292,035

(22) PCT Filed: Nov. 11, 2019
(86) PCT No.: PCT/JP2019/044124

§ 371 Date: May 7, 2021

(30) Foreign Application Priority Data
Nov. 16, 2018 (JP) 2018-215330

(51) Int. Cl. G01S 17/36; G01S 7/497

(52) U.S. Cl. CPC G01S 17/36; G01S 7/497

(57) ABSTRACT

An object of the present disclosure is to provide an optical distance measurement device and an optical distance measurement method that make it easier to generate calibration information used for calibrating a measured distance. An optical distance measurement device (10) according to the present disclosure includes a light emitting section (110) that emits beams of distance measurement light, the beams of distance measurement light including at least a first light component and a second light component and being in different states; a reflection section (200) that reflects the first light component; a light receiving section (120) that receives the first light component reflected by the reflection section and the second light component reflected from a distance measurement target (15) different from the reflection section while distinguishing between the first light component and the second light component; a calibration information generation section (440) that generates, according to relation between a timing at which the distance measurement light is emitted by the light emitting section and a phase of the first light component received by the light receiving section, calibration information (calibration table 441) used for calibrating a distance determined from a phase of the second light component received by the light receiving section; and a calculation section (450) that calculates the calibrated distance according to the phase of the second light component received by the light receiving section and the calibration information.

### TECHNICAL FIELD

The present disclosure relates to an optical distance measurement device and an optical distance measurement method.

### BACKGROUND ART

Conventionally used is an optical distance measurement device having a TOF (Time of Flight) sensor. The TOF sensor measures the distance to a measurement target according to the phase difference between distance measurement light emitted toward the measurement target and distance measurement light reflected from the measurement target and received by a light receiving section. When such a conventional optical distance measurement device is used, measurement error occurs, due to various error factors, between the true value (Ground Truth) of a measured distance value and a measured (Calculated) distance. Therefore, when such a conventional optical distance measurement device is used, calibration is generally performed to correct the above-mentioned measurement error (refer, for example, to PTL 1).

### CITATION LIST

### PATENT LITERATURE

### PTL 1

U.S. Patent Application Publication No. 2009/0020687

### SUMMARY

### Technical Problems

In order to calibrate a measured distance, it is necessary to examine the correspondence between the true value of a measured distance value and a distance measured by an optical distance measurement device. The optical distance measurement device measures a distance by emitting light for calibration so as to let it pass through a predetermined path and allowing a light receiving section to receive the calibration light. The optical distance measurement device then uses the measured distance thus obtained to generate information for distance calibration.

When a technology described in PTL 1 is used, it is necessary to generate calibration information used for calibrating a measured distance by disposing, for example, a light shielding plate between two light receiving sections. One of the two light receiving sections is used to calibrate a distance, and the other one is used to measure the distance to a measurement target. The light shielding plate is used to avoid interference between light incident on one of the light receiving sections and distance measurement light incident on the other light receiving section. This not only complicates the structure of a module for receiving the light, but also increases the cost of manufacturing the module.

The present disclosure has been made in view of the above circumstances. An object of the present disclosure is to provide an optical distance measurement device and an optical distance measurement method that make it easier to generate calibration information used for calibrating a measured distance.

### Solution to Problems

According to the present disclosure, there is provided an optical distance measurement device including a light emitting section, a reflection section, a light receiving section, a calibration information generation section, and a calculation section. The light emitting section emits beams of distance measurement light that include at least a first light component and a second light component and are in different states. The reflection section reflects the first light component. The light receiving section receives the first light component reflected by the reflection section and the second light component reflected from a distance measurement target different from the reflection section while distinguishing between the first light component and the second light component. The calibration information generation section generates, according to the relation between a timing at which the distance measurement light is emitted by the light emitting section and a phase of the first light component received by the light receiving section, calibration information used for calibrating a distance determined from a phase of the second light component received by the light receiving section. The calculation section calculates the calibrated distance according to the phase of the second light component received by the light receiving section and the calibration information.

Further, according to the present invention, there is provided an optical distance measurement method including emitting beams of distance measurement light that include at least a first light component and a second light component and are in different states; reflecting the first light component; receiving the reflected first light component and the second light component reflected from a distance measurement target while distinguishing between the first light component and the second light component; generating, according to the relation between a timing at which the distance measurement light is emitted and a phase of the received first light component, calibration information used for calibrating a distance determined from a phase of the received second light component; and calculating the calibrated distance according to the phase of the received second light component and the calibration information.

### BRIEF DESCRIPTION OF DRAWINGS

FIG. 1 is a diagram illustrating a configuration of an optical distance measurement system 1 according to a first embodiment.

FIG. 2 is a diagram illustrating a light receiving surface 130 on which a light receiving section 120 according to the first embodiment receives distance measurement light.

FIG. 3 is a functional block diagram illustrating a configuration of a processing section 400.

FIG. 4 is a timing diagram illustrating the intensity of the distance measurement light emitted by a light emitting section 110 and the exposure amount of first and second light components received by the light receiving section 120.

FIG. 5 is an IQ diagram illustrating the distance measurement light and the first and second light components.

FIG. 6 is a diagram illustrating a calibration table 441 that contains calibration information.

FIG. 7 is a diagram illustrating an example of processing performed by an optical distance measurement device 10 according to the first embodiment.

FIG. 8 is a diagram illustrating a configuration of an optical distance measurement system 2 according to a first modification.

FIG. 9 is a diagram illustrating a light receiving surface 140 of a light receiving section 121 according to the first modification.

FIG. 10 is a diagram illustrating an example of a light receiving surface 150 of the light receiving section 121 according to the first modification.

FIG. 11 is a diagram illustrating a configuration of an optical distance measurement system 3 according to a second modification.

### DESCRIPTION OF EMBODIMENTS

Preferred embodiments of the present disclosure will now be described in detail with reference to the accompanying drawings. It should be noted that, in the following description and the accompanying drawing, elements having substantially the same functionality are denoted by the same reference sign and will not be redundantly described.

Further, the description will be given in the following order.
1. First Embodiment
   1.1. Configuration of Optical Distance Measurement Device
   1.2. Example of Processing
   1.3. Advantages
2. First Modification
3. Second Modification
4. Supplement

### 1. First Embodiment

The TOF method is available in two different configurations, namely, a direct TOF method and an indirect TOF method. The direct TOF method is used to calculate the distance to a measurement target according to the time interval between the instant at which distance measurement light is emitted and the instant at which the distance measurement light is reflected back from the measurement target. The indirect TOF method is used to calculate the distance to the measurement target according to the phase difference between the emitted distance measurement light and the distance measurement light reflected from the measurement target. It is assumed that an optical distance measurement device described in conjunction with a first embodiment uses the indirect TOF method.

### 1.1. Configuration of Optical Distance Measurement Device

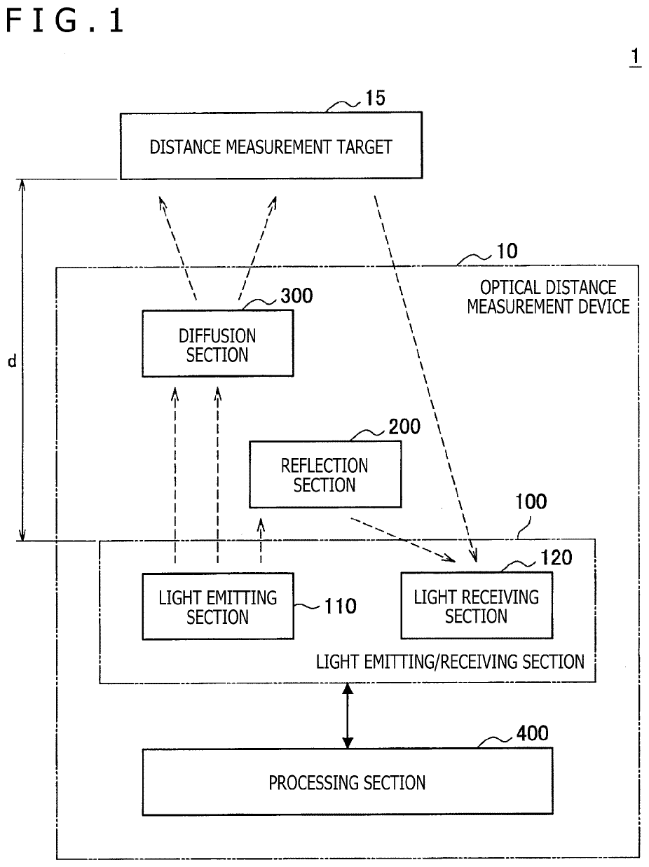

First of all, a schematic configuration of an optical distance measurement device 10 according to the first embodiment of the present disclosure will be described with reference to FIGS. 1 to 3. FIG. 1 is a diagram illustrating a configuration of an optical distance measurement system 1 according to the first embodiment. The optical distance measurement system 1 includes the optical distance measurement device 10 and a distance measurement target 15. It should be noted that, in order to facilitate understanding of the configuration of the optical distance measurement device 10, the optical distance measurement device 10 depicted in FIG. 1 is larger in size than the distance between the optical distance measurement device 10 and the distance measurement target 15. However, the distance between the optical distance measurement device 10 and the distance measurement target 15 may be longer than the size of the optical distance measurement device 10.

The optical distance measurement device 10 has a function of emitting beams of distance measurement light that include at least a first light component and a second light component and are in different states, reflecting the first light component, and receiving the distance measurement light while distinguishing between the reflected first light component and the second light component reflected from the distance measurement target 15. Further, the optical distance measurement device 10 has a function of generating, based on the phase of the emitted distance measurement light and the phase of the received first light component, calibration information used for calibrating a distance determined from the phase of the second light component received by a light receiving section 120, calculating the distance by using the phase of the received second light component, and calibrating the distance according to the calibration information. These functions of the optical distance measurement device 10 are implemented by the collaboration of a light emitting/receiving section 100, a reflection section 200, a diffusion section 300, and a processing section 400 which are included in the optical distance measurement device 10.

### Light Emitting/Receiving Section

The light emitting/receiving section 100 has a function of emitting the distance measurement light including at least the first and second light components, and a function of receiving the distance measurement light while distinguishing between the first light component reflected by the reflection section 200 and the second light component reflected by the distance measurement target 15. The functions of the light emitting/receiving section 100 are implemented by a light emitting section 110 and the light receiving section 120 which are included in the light emitting/receiving section 100. It should be noted that broken line arrows depicted in FIG. 1 represent a path through which the distance measurement light passes (i.e., distance measurement light path). Further, the distance between the light emitting/receiving section 100 and the distance measurement target 15 is d. Here, the first light component is a light component that is used for generating the calibration information. Further, the second light component is a light component that is used when the processing section 400 calculates the distance d calibrated based on the calibration information.

The light emitting section 110 has a function of emitting beams of the distance measurement light that include at least the first and second light components and are in different states. The light emitting section 110 includes, for example, various well-known light sources that emit light. Such light sources are not limited to specific types. However, it is convenient to use, for example, various laser light sources typified by various light emitting diodes, semiconductor lasers, and the like. Upon receiving a control signal from the processing section 400, the light emitting section 110 emits the distance measurement light. The light components included in the distance measurement light emitted by the light emitting section 110 may be light having wavelengths included in wavelength bands such as an infrared wavelength band, a visible light wavelength band, and an ultraviolet wavelength band, or may be light having wavelengths included in wavelength bands having a longer or shorter wavelength than any of the above-mentioned wavelength bands. Here, the first embodiment assumes, as an example, that the first light component and the second light component are in states differing in the polarization direction. More specifically, in the first embodiment, the polarization direction of the first light component and the polarization direction of the second light component are orthogonal to each other.

The first light component emitted by the light emitting section 110 is reflected by the reflection section 200. Further, the second light component emitted by the light emitting section 110 is diffused by the diffusion section 300 and reflected by the distance measurement target 15. The light receiving section 120 has a function of receiving the first light component reflected by the reflection section 200 and the second light component reflected by the distance measurement target 15 while distinguishing these light components from each other. The light receiving section 120 has various well-known light receiving elements including, for example, various photodiodes or various imaging elements such as CMOS sensors or CCD sensors. The light receiving section 120 receives the first or second light component to acquire information (e.g., information regarding the intensity of the received light component), and transmits the acquired information to the processing section 400. Using the acquired information makes it possible to identify phase information such as the information regarding the phase of the first light component or the phase of the second light component.

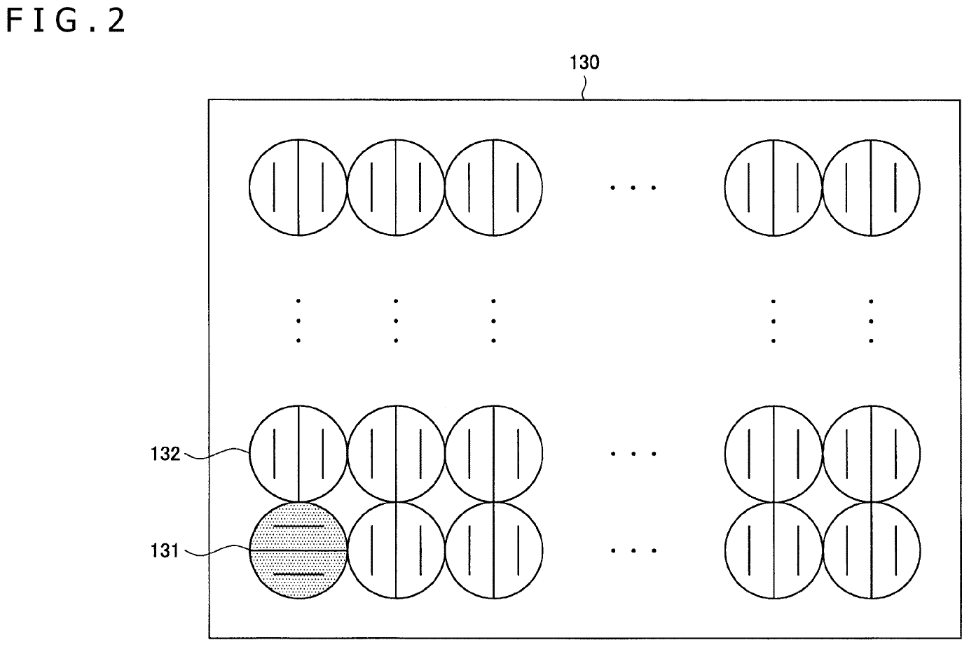

A configuration of the light receiving section 120 according to the first embodiment will now be described with reference to FIG. 2. FIG. 2 is a diagram illustrating a light receiving surface 130 on which the light receiving section 120 according to the first embodiment receives the distance measurement light. First light receiving elements 131 and second light receiving elements 132 are disposed on the light receiving surface 130. The first light receiving element 131 and the second light receiving element 132 may each be a photodiode or a pixel of various imaging elements such as CMOS (Complementary Metal Oxide Semiconductor) sensors and CCD (Charge Coupled Device) sensors. Here, the first light receiving element 131 has a function of receiving the first light component. Further, the second light receiving element 132 has a function of receiving the second light component.

The direction of straight lines marked inside a circle of the first light receiving element 131 and the direction of straight lines marked inside a circle of the second light receiving element 132 correspond to the polarization direction of the first light component and the polarization direction of the second light component, respectively. As the light receiving section 120 includes the above-described first and second light receiving elements 131 and 132, the light receiving section 120 is able to receive the first and second light components while distinguishing them from each other. More specifically, the single light receiving section 120 is able to receive a light component used for calibrating a measured distance and a light component used for calculating a distance while distinguishing the light components from each other. Therefore, the optical distance measurement device 10 according to the first embodiment does not need to have, for example, a shielding plate disposed between the light receiving elements for calibration and the light receiving elements for distance calculation. This makes it possible to implement the light receiving section 120 more easily. Further, in the present embodiment, the cost of the light receiving section 120 is reduced. This also reduces the cost of the optical distance measurement device 10.

Moreover, the first embodiment is configured such that the polarization direction of the first light component and the polarization direction of the second light component are orthogonal to each other. This prevents deterioration in the accuracy of calibration caused when the first light receiving elements 131 of the light receiving section 120 receive the second light component as noise. This also prevents deterioration in the accuracy of distance calculation caused when the second light receiving elements 132 of the light receiving section 120 receive the first light component as noise.

The present embodiment is configured such that the polarization direction of the first light component and the polarization direction of the second light component are orthogonal to each other. However, the present disclosure is not limited to such a configuration. It is only required that the polarization direction of the first light component and the polarization direction of the second light component are in different states, and the polarization directions need not always be orthogonal to each other. For example, in a case where the polarization direction of the second light component is slightly deviated from a direction orthogonal to the polarization direction of the first light component, the second light component is mainly received by the second light receiving elements 132. Therefore, the light receiving section 120 is able to receive the first and second light components while distinguishing them from each other.

Further, even when the polarization direction of the first light component and the polarization direction of the second light component are not orthogonal to each other, the light receiving section 120 is able to distinguish between the first and second light components by examining the mixture of the received first and second light components. The following describes, in more detail, a case where, for example, the polarization direction of the second light component differs by 45 degrees from the polarization direction of the first light. In such a case, the second light component is received evenly by the first light receiving elements 131 and the second light receiving elements 132. Meanwhile, the first light component is received by the first light receiving elements 131. Therefore, the first light receiving elements 131 receive the first and second light components. Meanwhile, the second light receiving elements 132 receive the second light component. Consequently, the phase of the received second light component can be identified by the second light receiving elements 132. Further, the phase of the first light component received by the first light receiving elements 131 can be determined by subtracting a light component having the same intensity as the second light component received by the second light receiving elements 132, from the light component received by the first light receiving elements 131. As described above, when the polarization direction of the first light component and the polarization direction of the second light component are different from each other, the light receiving section 120 is able to receive the first and second light components while distinguishing them from each other. As a result, the light receiving section 120 can be implemented more easily.

It should be noted that the light receiving section 120 may include, for example, various optical elements, such as lenses for collecting the distance measurement light, or a holder for protecting the lenses and the light receiving surface 130.

### Reflection Section

The reflection section 200 has a function of reflecting the distance measurement light that is emitted from the light emitting section 110 and propagated to the reflection section 200. More specifically, the reflection section 200 has a function of reflecting the first light component included in the distance measurement light that reaches the reflection section 200. The reflection section 200 may include an optical element such as a mirror capable of reflecting light or include various members including materials having a relatively high reflectance in the wavelength region of the first light component. The reflection section 200 may be a notched mirror body including materials having the above-mentioned relatively high reflectance. Further, the reflection section 200 may be in any shape as long as it is shaped to be able to reflect the distance measurement light. For example, the reflection section 200 may be a board-shaped reflective plate, a protruded reflective plate, a multi-sided reflective plate, or the like. The shape of the reflection section 200 is determined as appropriate according to, for example, the positional relation between the light emitting section 110 and the light receiving section 120 or the positions or number of the light receiving elements included in the light receiving section 120.

Further, the reflection section 200 may selectively reflect only the first light component having a predetermined state. For example, the reflection section 200 may selectively reflect the first light component having a predetermined polarization state. Further, the reflection section 200 may selectively reflect the first light component in a predetermined wavelength region. When the reflection section 200 selectively reflects the first light component, the light receiving section 120 is able to receive the distance measurement light while distinguishing between the first light component and the other light components more accurately. This makes it possible to further improve the accuracy of the calibrated distance d which is calculated by the processing section 400.

### Diffusion Section

The diffusion section 300 has a function of diffusing the distance measurement light emitted by the light emitting section 110. Various well-known diffusion plates including, for example, glass may be used as the diffusion section 300. When diffused by the diffusion section 300, the distance measurement light reaches the distance measurement target 15 more reliably. This enables the optical distance measurement device 10 to measure the distance d more easily. In the first embodiment, the diffusion section 300 is disposed in the path through which the distance measurement light emitted by the light emitting section 110 passes, and is positioned downstream of the reflection section 200. The distance measurement light diffused by the diffusion section 300 is reflected by the distance measurement target 15 and received by the light receiving section 120.

The diffusion section 300 may selectively diffuse the second light component. For example, when the diffusion section 300 is provided with a filter for selective transmission in the polarization direction of the second light component, the diffusion section 300 is able to selectively diffuse the second light component. In such a case, the second light component is selectively reflected by the distance measurement target 15 and received by the light receiving section 120. This enables the light receiving section 120 to receive the second light component and the other light components while distinguishing the light components from each other more accurately.

### Processing Section

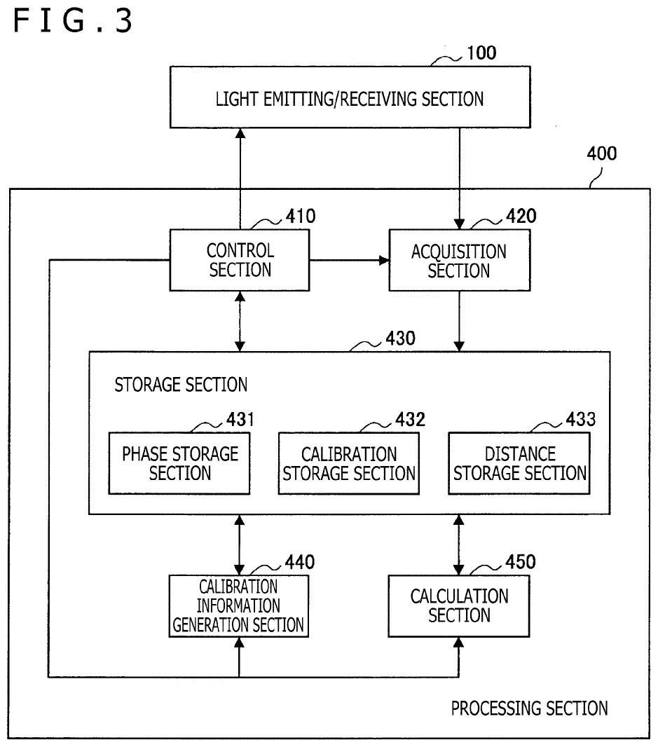

A configuration and functions of the processing section 400 will next be described with reference to FIG. 3. FIG. 3 is a functional block diagram illustrating a configuration of the processing section 400. The processing section 400 includes various well-known arithmetic processing units, such as a CPU (Central Processing Unit), and various well-known storage devices, such as a ROM (Read Only Memory) and a RAM (Random Access Memory).

The processing section 400 has a function of controlling the operation of the light emitting/receiving section 100. Further, the processing section 400 has a function of generating the calibration information according to the phase of the distance measurement light emitted by the light emitting section 110 and the phase of the first light component received by the light receiving section 120. Further, the processing section 400 has a function of calculating a distance by using the phase of the second light component received by the light receiving section 120, and calibrating the distance according to the calibration information. The functions of the processing section 400 are implemented when a control section 410, an acquisition section 420, a storage section 430, a calibration information generation section 440, and a calculation section 450 which are included in the processing section 400 operate in an appropriate manner.

The control section 410 has a function of controlling the operation of the light emitting/receiving section 100. More specifically, the control section 410 controls an operation performed by the light emitting section 110 to emit the distance measurement light, and controls an operation performed by the light receiving section 120 to receive the first and second light components. For example, the control section 410 transmits, to the light emitting section 110, information indicating distance measurement light emission conditions, such as a timing at which the light emitting section 110 emits the distance measurement light, and the wavelength, polarization direction, or intensity of light components included in the distance measurement light emitted by the light emitting section 110. The information indicating how the control section 410 controls the light emitting/receiving section 100 is transmitted to the calibration information generation section 440 or the calculation section 450.

Further, the control section 410 transmits a light reception signal to the light receiving section 120. The light reception signal is used to determine a light-receiving timing at which the light receiving section 120 receives the first or second light component. Upon receiving the light reception signal, the light receiving section 120 starts a light receiving operation. Further, the control section 410 transmits a light emission signal to the light emitting section 110. The light emission signal is used to control a light-emitting timing at which the light emitting section 110 emits the distance measurement light. Upon receiving the light emission signal, the light emitting section 110 emits the distance measurement light. The control section 410 may transmit the light emission signal and the light reception signal to the light emitting section 110 and the light receiving section 120, respectively, such that the light-emitting timing and the light-receiving timing are simultaneous. Moreover, the control section 410 may transmit the light emission signal and the light reception signal to the light emitting section 110 and the light receiving section 120, respectively, such that the light-emitting timing is later than the light-receiving timing. This enables the control section 410 exercise control such that the light-receiving timing is later than the light-emitting timing by a desired delay time.

The acquisition section 420 has a function of acquiring information from the light emitting/receiving section 100 or the control section 410. More specifically, the acquisition section 420 acquires various types of light reception information regarding the first or second light component received by the light receiving section 120. The acquired information may be information regarding, for example, a timing at which the first or second light component is received, or may be information regarding, for example, the phase or intensity of the first or second light component. The acquisition section 420 transmits the acquired information to the storage section 430.

The storage section 430 has a function of storing information that is acquired or generated by the processing section 400. The function of the storage section 430 is implemented by a phase storage section 431, a calibration storage section 432, and a distance storage section 433 which are included in the storage section 430.

The phase storage section 431 has a function of storing a first phase and a second phase. The first phase and the second phase are the phases of the first light component and the second light component received by the light receiving section 120, respectively.

The calibration storage section 432 has a function of storing the calibration information generated by the calibration information generation section 440. The calibration information indicates the relation between a measured phase and a phase corresponding to the true value of a measured distance value. The calculation section 450 uses the calibration information to calculate the calibrated distance d.

The calibration information generation section 440 has a function of generating the calibration information according to a delay value of the distance measurement light emitted from the light emitting section 110 and the phase of the first light component received by the light receiving section 120. The calibration information generated by the calibration information generation section 440 is stored in the calibration storage section 432.

The calculation section 450 calculates the calibrated distance d according to the second phase and the calibration information. More specifically, the calculation section 450 calculates the calibrated distance d according to the calibration information and a phase calculated by subtracting a delay phase from the second phase. In such a manner, the distance d free of measurement error is calculated. Here, the measurement error includes an offset error indicating a certain value deviation from the true value, an error proportional to the magnitude of the true value, and a cyclic error that periodically varies with respect to the true value. Particularly, the cyclic error is unavoidable during the use of the indirect TOF method adopted in the present embodiment. However, the above-described calibration processing is performed in the present embodiment. Therefore, the offset error and the cyclic error are eliminated to calculate the calibrated distance d.

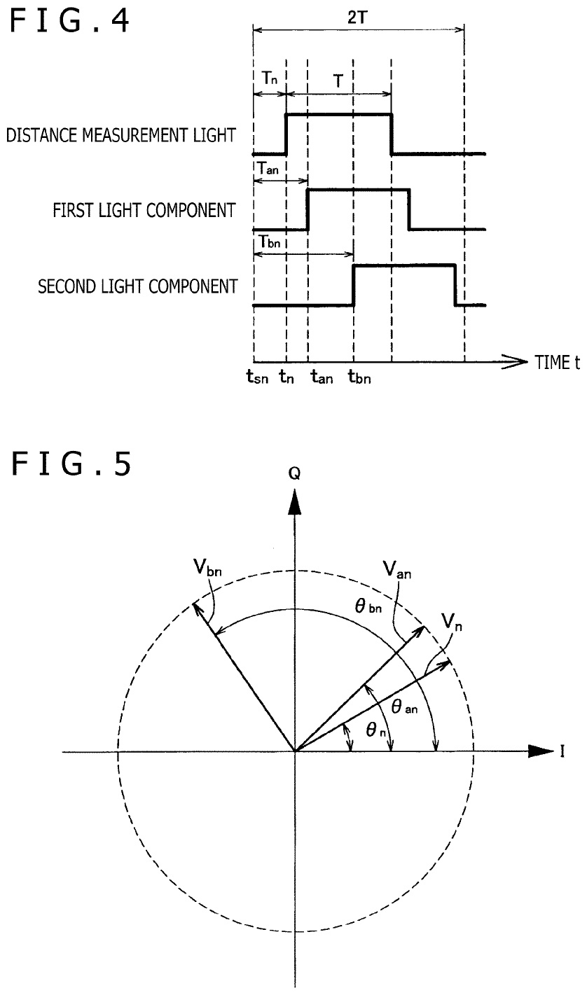

A process performed by the processing section 400 to let the light emitting/receiving section 100 emit or receive the distance measurement light and calculate a calibrated distance will now be described in more detail with reference to FIGS. 4 to 6. FIG. 4 is a timing diagram illustrating the intensity of the distance measurement light emitted by the light emitting section 110 and the exposure amount of first and second light components received by the light receiving section 120.

As an example, the following describes a case where the control section 410 causes the light emitting section 110 to emit the distance measurement light with a rectangular waveform having a pulse width T. It should be noted that the period in such a case is assumed to be 2T. However, the period may be any value irrespective of the pulse width T.

Depicted in the timing diagram in FIG. 4 are, from top to bottom, the distance measurement light emitted by the light emitting section 110, the first light component received by the light receiving section 120, and the second light component received by the light receiving section 120. The control section 410 causes the light emitting section 110 to emit the distance measurement light at time tₙ which is later by a delay time Tₙ than time tₛₙ. Here, tₛₙ is the time at which the light receiving section 120 receives the light reception signal from the control section 410. That is, the light emitting section 110 emits the distance measurement light at the time tₙ which is later by the delay time Tₙ than the time tₛₙ at which the light receiving section 120 receives the light reception signal.

There is a certain time interval between the instant at which the first light component is emitted by the light emitting section 110 and the instant at which the emitted first light component is reflected by the reflection section 200 and received by the light receiving section 120. Therefore, time tₐₙ at which the first light component is received by the light receiving section 120 is later than the time tₙ, and the first light component is received by the light receiving section 120 at the time tₐₙ which is later than the time tₛₙ by a first light receiving time Tₐₙ. Further, there is a certain time interval between the instant at which the second light component is emitted by the light emitting section 110 and the instant at which the emitted second light component is reflected by the distance measurement target 15 and received by the light receiving section 120. Therefore, the second light component is received by the light receiving section 120 at time t_{bn} which is later than the time tₛₙ by a second light receiving time T_{bn}.

Here, the delay time Tₙ, the first light receiving time Tₐₙ, and the second light receiving time T_{bn} are each expressed as a phase. More specifically, the above time values are each expressed as a phase on the assumption that the period 2T is 2π. That is, the delay time Tₙ is expressed as a delay phase θₙ=πTₙ/T, the first light receiving time Tₐₙ is expressed as a first phase θₐₙ=πTₐₙ/T, and the second light receiving time T_{bn} is expressed as a second phase θ_{bn}=πT_{bn}/T. The light receiving section 120 measures the first phase and the second phase by using, for example, the well-known electric charge distribution method.

FIG. 5 is an IQ diagram that uses complex vectors to illustrate the distance measurement light emitted by the light emitting section 110 and the first and second light components received by the light receiving section 120. A vector Vₙ corresponding to the distance measurement light has the delay phase θₙ. A vector Vₐₙ corresponding to the first light component has the first phase θₐₙ. A vector V_{bn} corresponding to the second light component has the second phase θ_{bn}. It should be noted that, for the sake of simplicity, the respective vectors are assumed to have the same magnitude.

The light receiving section 120 measures the first phase θₐₙ and the second phase θ_{bn}. Further, the light receiving section 120 transmits the first phase θₐₙ and the second delay phase θ_{bn} to the storage section 430 through the acquisition section 420. The control section 410 transmits the delay phase θₙ to the storage section 430.

The control section 410 sequentially changes the delay phase θₙ and causes the light emitting section 110 to emit the distance measurement light. The light receiving section 120 measures the first phase can and second phase θ_{bn} corresponding to respective beams of the distance measurement light that differ in the delay phase θₙ. The delay phase θₙ, the first phase θₐₙ, and the second phase θ_{bn} are stored by the phase storage section 431. The calibration information generation section 440 generates the calibration information according to the delay phase θₙ and the first phase θₐₙ.

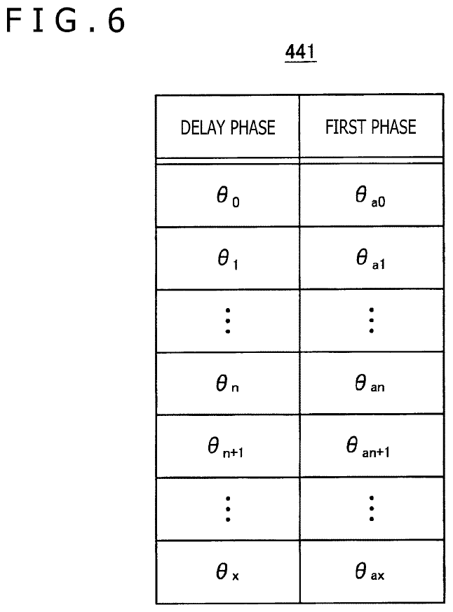

A concrete example of the calibration information generated by the calibration information generation section 440 will now be described with reference to FIG. 6. FIG. 6 is a diagram illustrating a calibration table 441 that is a concrete example of the calibration information. The calibration table 441 indicates the delay phase θₙ and the first phase θₐₙ.

Here, it is described how the calibration table 441 is used to calculate the calibrated distance d. Here, n may be x numerical values between 1 and x. That is, x pieces of the delay phase and x pieces of the first phase are entered in the calibration table 441. It should be noted that θₙ may be a value between 0 and 2π. Further, the difference between the pieces of the delay phase θₙ having adjacent subscript numbers may be, for example, 2π/x.

In the above instance, a change in the delay value θₙ corresponds to a change in the distance d for the light emitting/receiving section 100. For example, a case where the control section 410 delays the delay value θₙ by Δθ corresponds to a case where the distance d is increased by cTΔθ/2π. Therefore, the calibration table 411 indicates the first phase can that occurs in a case where the distance d is changed by a distance corresponding to the delay phase θₙ. Further, already known is the path through which the first light component passes during the time interval between the instant at which the first light component is emitted from the light emitting section 110 and the instant at which the emitted first light component is reflected by the reflection section 200 and received by the light receiving section 120. Consequently, the relation between a measured phase and a phase corresponding to the true value of the distance d is revealed by using the calibration table 411.

By using the above-described calibration table 411, the calculation section 450 is able to calculate the calibrated distance d. More specifically, the calculation section 450 calculates the difference between the second phase θ_{bn} and the delay phase θₙ. Further, based on the calculated difference and the calibration table 411, the calculation section 450 calculates the calibrated distance d. The distance storage section 433 then stores the calibrated distance d.

### 1.2. Example of Processing

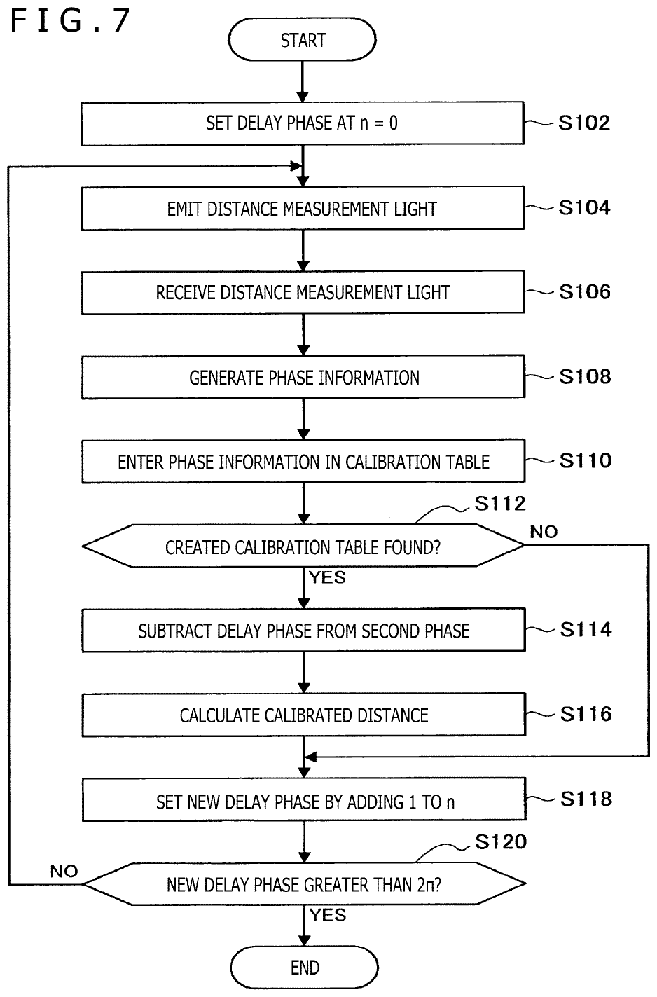

An example of processing performed by the optical distance measurement device 10 according to the first embodiment will next be described with reference to FIG. 7.

First of all, the control section 410 sets a delay phase θ₀ at n=0 (step S102). Here, the delay phase θ₀ may be, for example, 0 (rad). The control section 410 transmits information regarding the set delay phase θ₀ to the phase storage section 431 to let the phase storage section 431 store the delay phase θ₀.

Next, the control section 410 causes the light emitting section 110 to emit the distance measurement light (step S104). More specifically, the control section 410 transmits the light reception signal to the light receiving section 120, and transmits the light emission signal to the light emitting section 110 so as to let the light emitting section 110 emit the distance measurement light at a time point that is later by the delay time Tₙ than a time point at which the light receiving section 120 receives the light reception signal. The first light component included in the distance measurement light is partly reflected by the reflection section 200. Further, the second light component included in the distance measurement light is partly reflected by the distance measurement target 15.

Next, the light receiving section 120 receives the first light component and the second light component (step S106). The received first light component is a first light component that is reflected by the reflection section 200 in step S104. Further, the received second light component is a second light component that is reflected by the distance measurement target 15 in step S104.

Next, the light receiving section 120 generates the phase information regarding the first and second light components received in step S106 (step S108). More specifically, based on the received first and second light components, the light receiving section 120 generates the first phase θₐₙ and the second phase θ_{bn} as the phase information. The light receiving section 120 transmits the generated phase information to the phase storage section 431 through the acquisition section 420. The phase storage section 431 stores the phase information.

Next, based on the phase information stored in the phase storage section 431, the calibration information generation section 440 enters the phase information in the calibration table possessed by the calibration information generation section 440 (step S110). More specifically, the calibration information generation section 440 enters the first phase θₐₙ in the calibration table in such a manner as to associate the delay phase θₙ with the first phase θₐₙ.

Next, the calibration information generation section 440 determines whether or not there is a created calibration table in the calibration storage section 432 (step S112). In a case where it is determined that there is a created calibration table (“YES” in step S112), processing proceeds to step S114. On the other hand, in a case where it is determined that there is no created calibration table (“NO” in step S112), processing proceeds to step S118.

If it is determined in step S112 that there is a created calibration table, then the calculation section 450 subtracts the delay phase θₙ from the second phase θ_{bn} (step S114).

Next, based on the calibration table 441 stored by the calibration storage section 432, the calculation section 450 calibrates an uncalibrated distance which is calculated in step S114 (step S116). The calibrated distance d is thus calculated. The distance storage section 433 then stores the calculated distance d.

Next, the control section 410 sets a new delay phase θₙ₊₁ by adding 1 to n (step S118). The control section 410 may set the new delay phase θₙ₊₁ by adding, for example, π/10 to the previous delay phase θₙ.

Next, the control section 410 determines whether or not the new delay phase θₙ₊₁ which is set in step S118 is greater than 2π (step S120). In a case where it is determined that the new delay phase θₙ₊₁ is greater than 2π (“YES” in step S120), the processing depicted in FIG. 7 terminates. In this instance, the control section 410 informs the calibration information generation section 440 that the new delay phase θₙ₊₁ is greater than 2π. Then, according to the generated calibration table 441, the calibration information generation section 440 updates the calibration table 441 stored in the calibration storage section 432.

On the other hand, in a case where it is determined that the new delay phase θₙ₊₁ is not greater than 2π (“NO” in step S120), processing returns to step S104.

The processing performed by the optical distance measurement device 10 according to the first embodiment has been described above.

### 1.3. Advantages

Advantages of the present embodiment will next be described. In the present embodiment, the light emitting section 110 emits the distance measurement light that includes the first light component and the second light component (step S104). The light receiving section 120 receives the distance measurement light while distinguishing between the first light component and the second light component (step S106). The calibration information generation section 440 generates the calibration information according to the relation between the delay phase θₙ and the first phase θₐₙ (step S110). Further, the calculation section 450 calculates the calibrated distance d according to the second phase θ_{bn} and the calibration information(steps S114 and S116).

In the above-described manner, the optical distance measurement device 10 according to the present embodiment is able to calculate the calibrated distance d by using one light receiving section 120. Therefore, the optical distance measurement device 10 according to the present embodiment does not need to separately have a light receiving section used for generating the calibration information, in addition to a light receiving section used for calculating an uncalibrated distance. Consequently, the present embodiment makes it easier to generate the calibration information used for calibrating the measured distance d.

Further, by changing the delay phase θₙ, the control section 410 according to the present embodiment changes the distance between the light emitting/receiving section 100 and the distance measurement target 15 in a pseudo manner, and then generates the calibration information. Therefore, the optical distance measurement device 10 according to the present embodiment does not need to reposition the distance measurement target 15 or the light emitting/receiving section 100 for the purpose of generating the calibration information. Consequently, the optical distance measurement device 10 makes it easier to generate the calibration information and calculate a calibrated distance.

### 2. First Modification

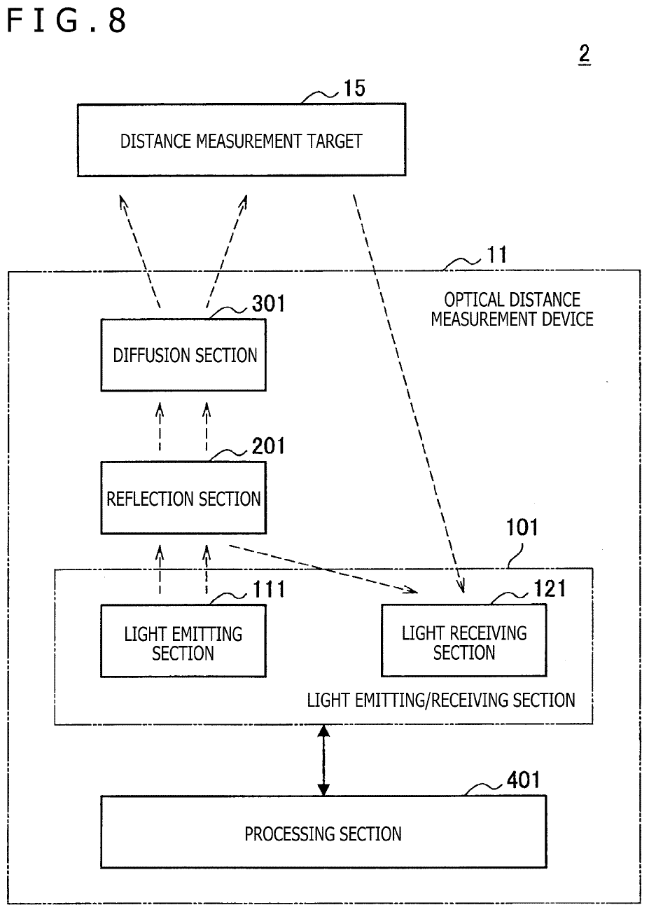

A first modification will next be described with reference to FIGS. 8 to 10. The following describes the difference from the first embodiment, and does not redundantly describe matters common to the first embodiment.

FIG. 8 is a diagram illustrating a configuration of an optical distance measurement system 2 according to the first modification. Similarly to the optical distance measurement device 10, an optical distance measurement device 11 includes a light emitting/receiving section 101, a reflection section 201, a diffusion section 301, and a processing section 401. In the first embodiment, the state of the first light component and the state of the second light component differ in the polarization direction of the light components. On the other hand, in the first modification, the state of the first light component and the state of the second light component differ in the wavelength of the light components. That is, in the first modification, the wavelength of the first light component and the wavelength of the second light component differ from each other. Further, a light receiving section 121 may include a first light receiving element that receives a light component having the wavelength of the first light component, and a second light receiving element that receives a light component having the wavelength of the second light component.

For example, the wavelengths of the first and second light components emitted by a light emitting section 111 may be both within the visible light wavelength band. In such a case, the first light component and the second light component are visually recognizable. Therefore, it is possible to visually recognize that the distance measurement light is being emitted by the light emitting section 111.

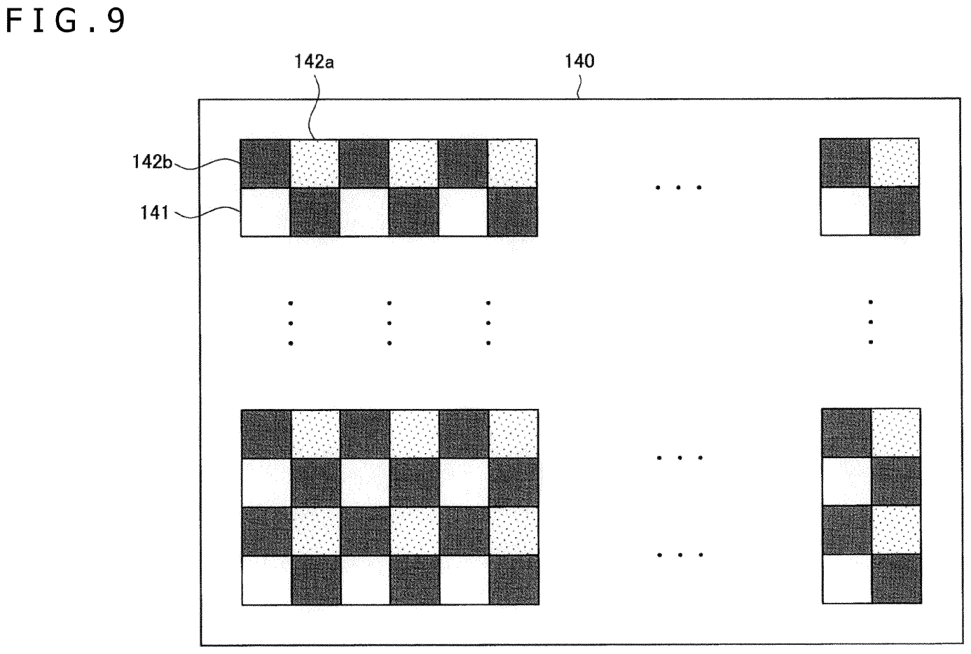

FIG. 9 is a diagram illustrating an example of a light receiving surface 140 of the light receiving section 121 according to the first modification. The light receiving section 121 receives the first and second light components emitted to the light receiving surface 140. First light receiving elements 141 and second light receiving elements 142a and 142b are disposed on the light receiving surface 140. Here, the first light component is a red light component having a wavelength of approximately 620 to 750 nm. Further, the second light component includes a blue light component having a wavelength of 450 to 495 nm and a green light component having a wavelength of 495 to 570 nm.

For example, the first light receiving elements 141 receive the red light component which is the first light component. In addition, the second light receiving elements 142a receive the blue light component included in the second light component. Further, the second light receiving elements 142b receive the green light component included in the second light component. In such a manner, the first light receiving elements 141 and the second light receiving elements 142 receive light components having different wavelengths. This enables the light receiving section 121 to receive the first and second light components while distinguishing between them.

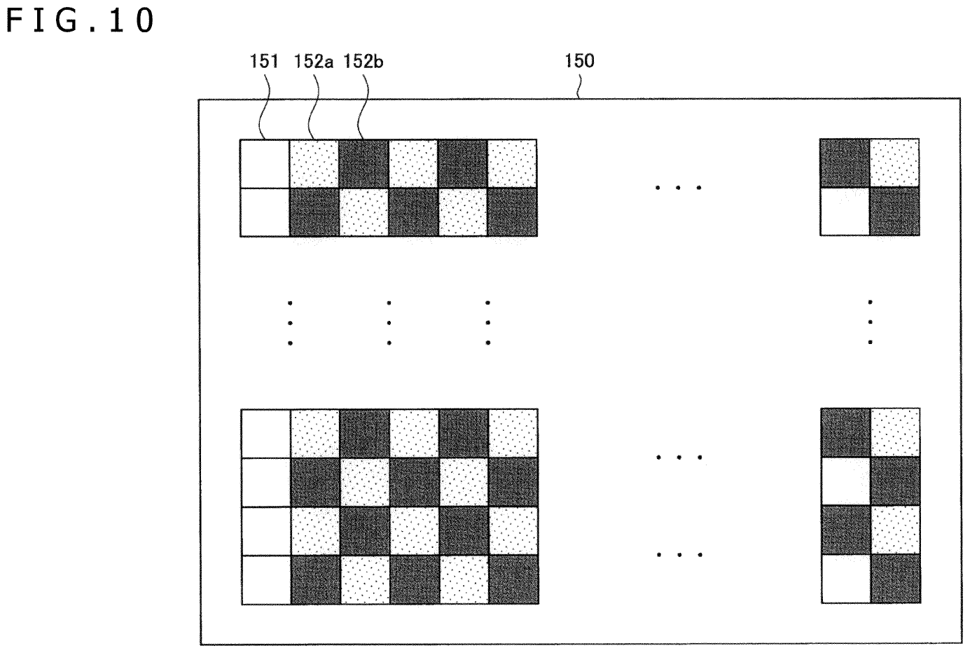

Further, the first light receiving elements 141 and second light receiving elements 142 in the light receiving section 121 need not always be laid out as indicated in the example of FIG. 9. Alternatively, first light receiving elements 151 and second light receiving elements 152 may be laid out on a light receiving surface 150 as indicated in FIG. 10. FIG. 10 is a diagram illustrating an example of the light receiving surface 150 of the light receiving section 121 according to the first modification. The light receiving surface 150 depicted in FIG. 10 is configured such that the first light receiving elements 151 are disposed on the left end of the light receiving surface 150. On the other hand, the second light receiving elements 152 are disposed, on the whole, on a portion of the light receiving surface 150 on which no first light receiving elements 151 are disposed. More specifically, the second light receiving elements 152 are disposed on the light receiving surface 150 in such a manner that the second light receiving elements 152a that receive the blue light component and the second light receiving elements 152b that receive the green light component alternate with each other.

Moreover, the wavelength of the first light component may be within the visible light wavelength band, and the wavelength of the second light component may be within the infrared wavelength band. This ensures that the second light component reflected by the distance measurement target 15 is not visually unrecognized. Therefore, users of the optical distance measurement device 11 will not be bothered by the second light component reflected by the distance measurement target 15.

### 3. Second Modification

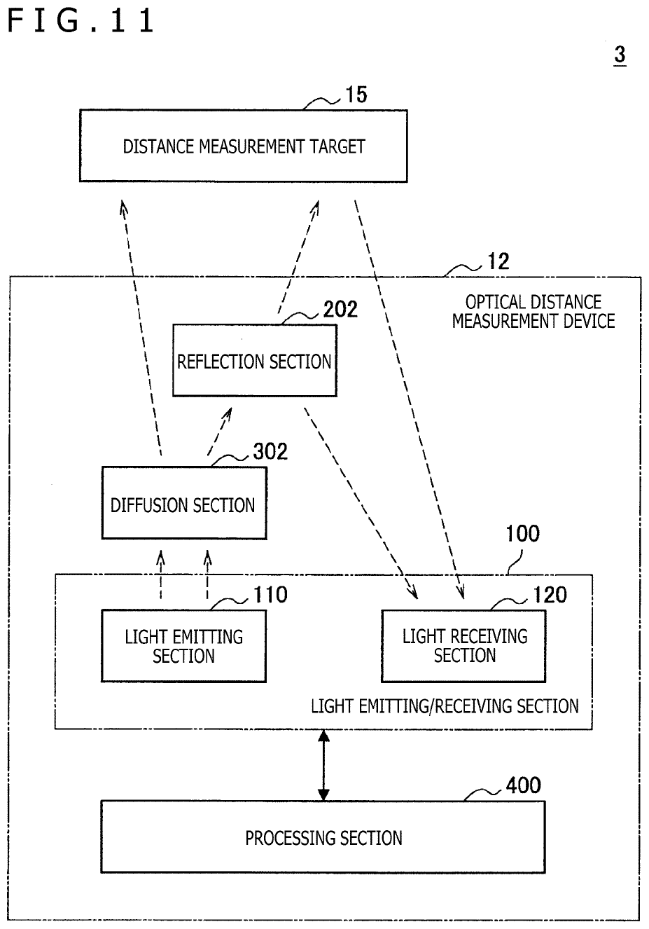

A second modification will next be described with reference to FIG. 11. The following describes the difference between the second modification and the first embodiment, and does not redundantly describe matters common to the first embodiment.

FIG. 11 is a diagram illustrating a configuration of an optical distance measurement system 3 according to the second modification. An optical distance measurement device 12 according to the second modification differs from the optical distance measurement device 10 according to the first embodiment in the positional relation between a reflection section 202 and a diffusion section 302. More specifically, in the second modification, the reflection section 202 is disposed in the path through which the distance measurement light emitted from the light emitting section 110 passes, and is positioned downstream of the diffusion section 302. Therefore, the reflection section 202 reflects the distance measurement light diffused by the diffusion section 302.

In the second modification, the light emitting section 110 emits the distance measurement light including the first and second light components that differ in the polarization direction, similarly to the first embodiment. The reflection section 202 selectively reflects only a light component having the polarization direction of the first light component. Therefore, the reflection section 202 selectively reflects only the first light component among the light components included in the distance measurement light.

### 4. Supplement

The preferred embodiments of the present disclosure have been described in detail with reference to the accompanying drawings. However, the technical scope of the present disclosure is not limited to the foregoing examples. It is obvious that a person having general knowledge in the technical field of the present disclosure can conceive various alterations and modifications within the scope of the technical ideas described in the appended claims. It is to be understood that such alterations and modifications are also encompassed within the technical scope of the present disclosure.

Further, the respective steps of processing performed by an image processing device described in the document need not always be chronologically performed in a sequence depicted in the flowcharts. For example, the respective steps of processing of the optical distance measurement device 10 may be performed in a sequence different from a sequence depicted in the flowcharts or may be performed in a parallel manner.

For example, in a case where the wavelengths of the first and second light components are within the visible band, the first modification has been described with reference to an example in which the first light component is a red light component and the second light components are blue and green light components. However, the present technology is not limited to such an example. The first and second light components may have any wavelengths as long as they are within the visible band and different from each other.

Moreover, the advantages described in the document are merely explanatory or illustrative and are not restrictive. That is, the technology according to the present disclosure is capable of providing, in addition to or instead of the above- described advantages, other advantages obvious to a person skilled in the art related to the description in the document.

It should be noted that the following configurations also fall within the technical scope of the present disclosure.

(1)

An optical distance measurement device including:

a light emitting section that emits beams of distance measurement light, the beams of distance measurement light including at least a first light component and a second light component and being in different states;

a reflection section that reflects the first light component;

a light receiving section that receives the first light component reflected by the reflection section and the second light component reflected from a distance measurement target different from the reflection section while distinguishing between the first light component and the second light component;

a calibration information generation section that generates, according to relation between a timing at which the distance measurement light is emitted by the light emitting section and a phase of the first light component received by the light receiving section, calibration information used for calibrating a distance determined from a phase of the second light component received by the light receiving section; and a calculation section that calculates the calibrated distance according to the phase of the second light component received by the light receiving section and the calibration information.

(2)

The optical distance measurement device according to

in which a polarization direction of the first light component and a polarization direction of the second light component are in different states, and

the light receiving section includes a first light receiving element and a second light receiving element, the first light receiving element being adapted to receive a light component having the polarization direction of the first light component, the second light receiving element being adapted to receive a light component having the polarization direction of the second light component.

(3)

The optical distance measurement device according to (1) or (2),

in which a wavelength of the first light component and a wavelength of the second light component differ from each other, and

the light receiving section includes a first light receiving element and a second light receiving element, the first light receiving element being adapted to receive a light component having the wavelength of the first light component, the second light receiving element being adapted to receive a light component having the wavelength of the second light component.

(4)

The optical distance measurement device according to (3), in which the wavelength of the first light component and the wavelength of the second light component are both within a visible band.

(5)

The optical distance measurement device according to (3),

in which the wavelength of the first light component is within an infrared band, and

the wavelength of the second light component is within a visible band.

(6)

The optical distance measurement device according to any one of (1) to (5), in which the reflection section selectively reflects only the first light component.

(7)

The optical distance measurement device according to any one of (1) to (6), further including:

a diffusion section that diffuses the distance measurement light emitted from the light emitting section.

(8)

The optical distance measurement device according to (7), in which the diffusion section is disposed in a path through which the distance measurement light passes, positioned downstream of the reflection section, and adapted to selectively diffuse the second light component.

(9)

The optical distance measurement device according to any one of (1) to (8),

in which the light emitting section emits multiple beams of distance measurement light, the multiple beams of distance measurement light being emitted at different timings, and

the calibration information generation section generates the calibration information according to relation between a timing at which each of the multiple beams of distance measurement light is emitted by the light emitting section and each phase of the multiple first light components corresponding to respective ones of the multiple beams of distance measurement light, the multiple first light components being received by the light receiving section.

(10)

An optical distance measurement method including:

emitting beams of distance measurement light that include at least a first light component and a second light component and are in different states;

reflecting the first light component;

receiving the reflected first light component and the second light component reflected from a distance measurement target while distinguishing between the first light component and the second light component;

generating, according to relation between a timing at which the distance measurement light is emitted and a phase of the received first light component, calibration information used for calibrating a distance determined from a phase of the received second light component; and

calculating the calibrated distance according to the phase of the received second light component and the calibration information.

### REFERENCE SIGNS LIST

10: Optical distance measurement device
100: Light emitting/receiving section
110: Light emitting section
120: Light receiving section
131: First light receiving element
132: Second light receiving element
200: Reflection section
300: Diffusion section
400: Processing section
410: Control section
430: Storage section
440: Calibration information generation section
450: Calculation section

1. An optical distance measurement device comprising:
a light emitting section that emits beams of distance measurement light, the beams of distance measurement light including at least a first light component and a second light component and being in different states;
a reflection section that reflects the first light component;
a light receiving section that receives the first light component reflected by the reflection section and the second light component reflected from a distance measurement target different from the reflection section while distinguishing between the first light component and the second light component;
a calibration information generation section that generates, according to relation between a timing at which the distance measurement light is emitted by the light emitting section and a phase of the first light component received by the light receiving section, calibration information used for calibrating a distance determined from a phase of the second light component received by the light receiving section; and
a calculation section that calculates the calibrated distance according to the phase of the second light component received by the light receiving section and the calibration information.

2. The optical distance measurement device according to claim 1,
wherein a polarization direction of the first light component and a polarization direction of the second light component are in different states, and
the light receiving section includes a first light receiving element and a second light receiving element, the first light receiving element being adapted to receive a light component having the polarization direction of the first light component, the second light receiving element being adapted to receive a light component having the polarization direction of the second light component.

3. The optical distance measurement device according to claim 1,
wherein a wavelength of the first light component and a wavelength of the second light component differ from each other, and
the light receiving section includes a first light receiving element and a second light receiving element, the first light receiving element being adapted to receive a light component having the wavelength of the first light component, the second light receiving element being adapted to receive a light component having the wavelength of the second light component.

4. The optical distance measurement device according to claim 3, wherein the wavelength of the first light component and the wavelength of the second light component are both within a visible band.

5. The optical distance measurement device according to claim 3,
wherein the wavelength of the first light component is within an infrared band, and
the wavelength of the second light component is within a visible band.

6. The optical distance measurement device according to claim 1, wherein the reflection section selectively reflects only the first light component.

7. The optical distance measurement device according to claim 1, further comprising:
a diffusion section that diffuses the distance measurement light emitted from the light emitting section.

8. The optical distance measurement device according to claim 7, wherein the diffusion section is disposed in a path through which the distance measurement light passes, positioned downstream of the reflection section, and adapted to selectively diffuse the second light component.

9. The optical distance measurement device according to claim 1,
wherein the light emitting section emits multiple beams of distance measurement light, the multiple beams of distance measurement light being emitted at different timings, and the calibration information generation section generates
the calibration information according to relation between a timing at which each of the multiple beams of distance measurement light is emitted by the light emitting section and each phase of the multiple first light components corresponding to respective ones of the multiple beams of distance measurement light, the multiple first light components being received by the light receiving section.

10. An optical distance measurement method comprising:
emitting beams of distance measurement light that include at least a first light component and a second light component and are in different states;
reflecting the first light component;
receiving the reflected first light component and the second light component reflected from a distance measurement target while distinguishing between the first light component and the second light component;
generating, according to relation between a timing at which the distance measurement light is emitted and a phase of the received first light component, calibration information used for calibrating a distance determined from a phase of the received second light component; and
calculating the calibrated distance according to the phase of the received second light component and the calibration information.
